(19) United States
(12) Patent Application Publication
(10) Pub. No.: US 2007/0221420 A1
(43) Pub. Date: Sep. 27, 2007

(54) Engine motor hybrid car

(76) Inventor: Yoshioki Tomoyasu, Fujisawa-shi (JP)

Correspondence Address: Yoshioki Tomoyasu, 21-22, Mirokuji 3-chome, Fujisawashi, 251-0016, JP

(21) Appl. No.: 11/389,325

(22) Filed: Mar. 27, 2006

(51) Int. Cl. B60K 6/00

(52) U.S. Cl. 180/65.2

(57) ABSTRACT

The invention is directed to develop for the higher performance of the hybrid motor car by means of substituting the starter motor of the general motor car for the main motor by means of utilizing the magnet switch to operate the pinion gear to keep apart from engagement with the flywheel, thus enabling to drive the motor continuously when the engine starts operating beyond the critical value of the driving force under the control of the computer with the booster with the propeller enclosed with the duct and circulating pipe around the motor to cool the inside temperature to keep the performance at high efficiency.

### FIELD OF THE INVENTION

The present invention is generally directed to developing for the engine and motor hybrid car which is designed to be manufactured with much simpler design as compared with those of the conventional hybrid motor cars in lower production as well as running costs.

### BACKGROUND OF THE INVENTION

The motor car is required for saving fuels as well as decreasing exhausting gases from the environment's point of view. Thus, the hybrid car is expected to be a definite solution to the ecological countermeasure in the development for higher performance.

### DESCRIPTION OF THE PRIOR ART

The conventional hybrid car is most likely to depend on a very complicated mechanism on design for the running operation, thus causing for higher production as well as running costs.

### SAMMARY OF THE INVENTION

The invention is generally directed to develop for a hybrid car converting the starter motor which have been used as the motor to be utilized only at a start motion of the engine to the continuously driving motor designed to drive in continuation by the time when the engine is required for being substituted for a driving operation beyond the critical value of the driving force by minor changes in the layout of the electric circuit. Consequently, the consumption for fuels and subsequent exhausting gases are liable to be reduced considerably. Furthermore, this invention is directed to develop for the new design serving to switch over to alternative driving force, i.e., either engine or motor for the operation of the hybrid motor car.

### BRIEF DESCRIPTION OF THE DRAWINGS

FIG. 1: The functional diagram of the circuit to drive the hybrid car.

FIG. 2: Enlarged design of the automatic switch over to a driving force.

### DETAILED DESCRIPTION OF THE INVENTION

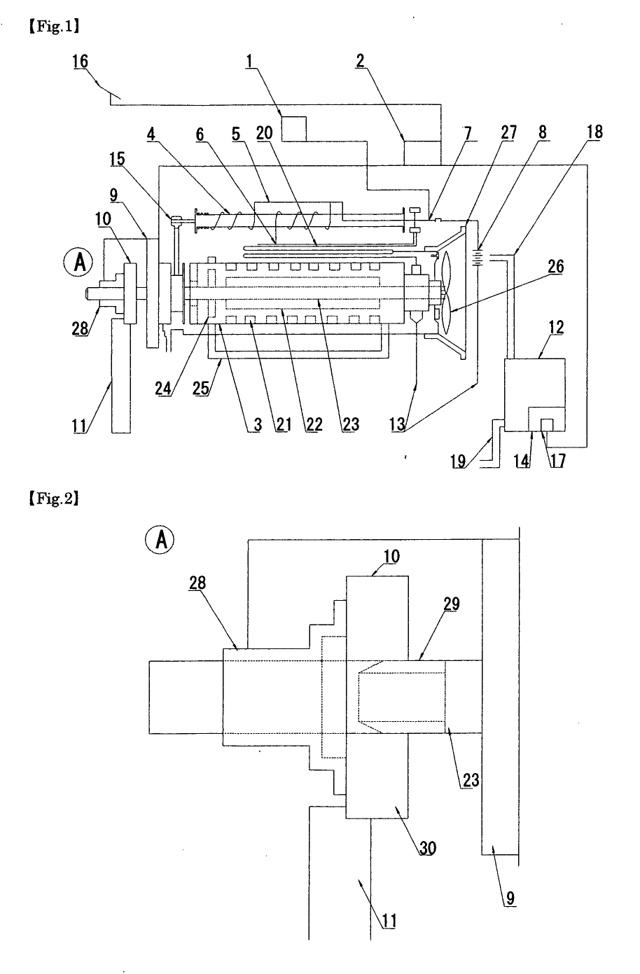

As shown FIG. 1, the present invention is directed to developing for the hybrid motor car with higher performance in driving operation than those of the conventional hybrid car by means of converting the starter motor(3) to a motor which is designed to be operated in general use continuously by the time when the engine is required for being substituted beyond the critical value of the driving force. When the ignition key(1) is switched on, the motor(3) is designed to start driving by transmitting the electric current through the circuit to the switch(9) to rotate the shaft(23) causing electric force which is augmented by the introduction of the propeller with the cylinder cover strong enough to drive the motor car at high efficiency. Furthermore, when the higher driving force is required in driving operation, the computer(2) is automatically designed to transmit the signal to the switch(9) to operate the magnet(28) for actuating the pinion gear of which inside wall is possible to slide along the spline(29) is processed in the engagement with the flywheel(11) to generate the crankshaft of the engine, and at the time when the driving force become below the value, the computer(2) transmit the signal to the magnet switch(28) to actuate the pinion gear(10) to remove from the engagement with the flywheel(11), eventually the driving operation is most likely to depend on the driving force of the motor(3).

In case where the driving force appear to be beyond the critical value again, the pinion gear(10) is also required to engage with the outside gear processed on the flywheel(11), the inside wall of the pinion collar(30) is liable to allow the top of tapered spline processed shaft to slide along the spline(29) to engage with each other. Furthermore, the inside temperature of the motor(3) which is closely related with the driving efficiency is possible to be kept in driving operation because of the circulation of the fluid to be circulated around the housing through the pipe(25) by the vane(24) of the pump set the inside of the motor(3).

1. The invention is related to the engine motor hybrid car which utilize the starter motor as the main motor to drive the motor car alternatively with the engine according to the driving force through the driving operation.

2. The starter motor of the above mentioned hybrid is designed to allow continuous driving operation to keep the pinion gear being apart from engagement with the flywheel by dint of the magnet switch under the control of the computer when the driving force is below the critical value, and when the driving force become beyond the value, the magnet switch in receipt of the signal from the computer operate to actuate the pinion gear of which inside wall is processed at spline to engage with the flywheel, thus generating with the operation driving engine.

3. The starter motor as above mentioned is designed to augment the driving power to be equipped with the propeller on the identical shaft to be enclosed with the cylinder and also designed to circulate the inside fluid through the circulating pipe to be cooled with the inside temperature.
